(19) United States
(12) Patent Application Publication
(10) Pub. No.: US 2014/0046677 A1
(43) Pub. Date: Feb. 13, 2014

(54) STREAMLINING INPUT OF EXERCISE AND NUTRITION LOGIC USING GEOGRAPHIC INFORMATION

(71) Applicant: GAL BAR-OR, Wilson, WY (US)

(72) Inventor: GAL BAR-OR, Wilson, WY (US)

(21) Appl. No.: 13/584,246

(22) Filed: Aug. 13, 2012

(51) Int. Cl. G06Q 50/22

(52) U.S. Cl. 705/2

(57) ABSTRACT

Streamlining input of exercise and nutrition logic. Identifying, for a user location, likely activities by the user, and nutrition or exercise information for those activities. Presenting most likely activities to the user, soliciting user input regarding activities. Updating probable future user activities in response to user input and menus of possible activities. Initially, presenting most likely activities when: most likely to occur at that location, most recently occurring at that location, most likely occurring for similar users, most likely occurring for users having similar preferences in other contexts. On a timeout, selecting activities on behalf of the user, deselecting activities, or adjusting the user's reliability.

### BACKGROUND

1. Field of the Disclosure

This application generally relates to healthcare management systems. More specifically, this application generally relates to systems for determining nutrition and exercise information for a user.

2. Background of the Disclosure

Healthcare management systems operate in part by receiving information with respect to nutrition and exercise of a patient, such as a user desiring to improve their health, or engaging in a plan or program of health improvement. For a first example, healthcare management systems might record that information with respect to nutrition and exercise of the patient, and compare that information with the plan or program of health improvement to be followed by the patient. For a second example, healthcare management systems might record that information with respect to nutrition and exercise of the patient, and compare that information with parameters for nutrition and exercise which are recommended by medical or other health-related authorities.

In a healthcare context, there are substantial benefits which can be achieved, for patients, for their families and other social contacts, for their employers and insurers, and for the community at large, for patients to use healthcare management systems. For example, patients can improve their behavior and behavioral patterns related to their health, such as related to improvement of nutrition and exercise considerations. This can have salutary effects, including the possibilities of improved health for patients, improved well-being for their families and other social contacts, reduced expenses for their employers and insurers, and other benefits for the community at large.

It sometimes occurs that entry of information with respect to nutrition and exercise of the patient can be a problematic task. For a first example, if that information is to be entered by persons other than the patient, such as medical personnel or nutritionists, that data entry involves access by those personnel to nutrition and exercise behaviors by the patient, such as by observing the patient's activities. For a second example, if that information is entered by the patient, that data entry involves access by the patient to information with respect to those nutrition and exercise behaviors. In both such examples, that data entry not only involves access to information, but that access to information should be relatively convenient, or data entry errors might occur, such as errors of omission or of entering incorrect information.

These issues are particularly problematic when that data entry is performed by the patient who is relatively busy, as relatively many patients are, with their other and regular activities, and who do not find it convenient to refer frequently to nutrition and exercise information. For a first example, for the patient who visits a restaurant, even a well-known restaurant, finding nutrition and exercise information about each item on a relatively lengthy menu might be a tedious task, with significant propensity for error. It sometimes occurs that the task is sufficiently tedious, or sufficiently prone to error, that the likelihood might be greatly reduced of the patient entering information that is both accurate and complete. For a second example, it might occur that there is insufficient detailed information at the point of entry, with the effect that an entire record of the event could be lost. It sometimes occurs that the patient (alternatively, another data entry person) does not have sufficient knowledge, access to information, or authorization to access information, of sufficient detailed information, and that detailed information is required just to make an entry of the event.

Each of these examples, as well as other possible considerations, can cause difficulty in aspects of a healthcare management system. For some examples, (A) the patient or other personnel charged with data entry might become frustrated, enter erroneous information, or fail to enter important information; (B) data maintained by the healthcare management system might be inaccurate or incomplete; (C) the healthcare management system might fail to provide realistic assessments or trusted recommendations; (D) medical personnel might have added difficulty with their responsibilities; (E) the patient might fail to see health or lifestyle improvements from the healthcare management system. Each of these might have a detrimental effect on the value of the healthcare management system.

### BRIEF SUMMARY OF THE DISCLOSURE

This application provides techniques for streamlining input of information relating to nutrition and exercise for a patient, such as daily activities by that patient relating to nutrition or exercise.

In one embodiment, techniques include identifying, in response to a user location, an activity likely to be performed by the user, and a set of information relating to nutrition or exercise associated with that activity. For example, a user location can be identified in response to a position location system such as the global positioning system (GPS), and in response to a database of known businesses and their locations and hours of operation. Information about the user location can be supplemented with other and further information, such as a time of day, a day of the week, one or more other recent activities by the user, and otherwise.

In one embodiment, techniques include presenting an activity likely to be performed by the user, such as by using a smart phone or other mobile device, and soliciting input from that user with respect to whether that activity is in fact being performed. For example, when the user enters a restaurant at which the system knows there is a high probability the user will order and consume a cheeseburger and a large soda, the system can ask if the user is, at that time, ordering or eating those items. Information about the user's activities can be used to update a set of probable future user activities, such as whether the user intends to continue the same activity, or to substitute some other activity, such as in response to a menu obtainable from a database with respect to that business establishment.

In one embodiment, if the user visits that location or business establishment for the first time, the system can present the user with a broad selection of possibilities, or can use information pertinent to a class of other users, such as (A) one or more events most likely to occur at that location or business establishment, (B) one or more events most recently occurring at that location or business establishment, (C) one or more events most likely to occur for users having similar characteristics, such as other users in related demographic categories, (D) one or more events most likely to occur for users having similar preferences in other contexts, or otherwise.

In one embodiment, if there is more than one likely activity deemed to be probable of performance by the user, the system can solicit input from the user with respect to whether one or more of those activities is in fact being performed, and if so, which ones. For example, when the user enters a suburban park at which the system knows there is a high probability the user will either (A) walk for ten minutes, (B) sit and read for thirty minutes, or (C) visit the snack bar and drink beer, the system can ask the user to choose one of those activities, or to select some other activity, and in the latter case, which one. Information about the user's activities can be used to update a set of probable future user activities, which information can be reflected in choices presented to the user in the future.

In one embodiment, techniques include, in the absence of a user response, such as after a selected timeout, automatically entering the user activity deemed most likely as the user activity deemed to have been actually performed. For example, when the system, after making a request for information, gets no response from the user for five minutes, the system can proceed as if the user did in fact act as the system deemed most likely. Information about how frequently the user fails to respond, or whether the user later corrects the system, can be used to update a set of probable future user activities, or the system's belief whether the user's lack of response is meaningful.

In one embodiment, techniques include dynamic assessment of likely events and of most reasonable information for data entry, such as (A) dynamically selected at the time of presentation, (B) in response to information available about users at the time of presentation, (C) in response to information about users who are similarly situated, (D) responsive to a set of rules, which are themselves responsive to information about the user, the user's current location, the user's past activities, the user's related current choices, the user's past choices, and otherwise.

After reading this application, those skilled in the art would recognize that techniques shown in this application are applicable to fields and information other than healthcare management systems. In the context of the invention, there is no particular requirement for any such limitation. Moreover, after reading this application, those skilled in the art would recognize that techniques shown in this application are applicable to methods and systems other than those involving data entry or by individuals. For example, other healthcare contexts can include frequent or important entry of data, such as related to improvement of sleep, stress and resiliency management, cessation of negative behaviors (such as tobacco use, excessive alcohol use, and otherwise), self care of other health considerations (such as back strain or back pain, diabetes or pre-diabetic condition management, weight loss, and otherwise), and training for athletic events. Similarly, non-healthcare contexts can include frequent or important entry of data, such as related to customer service, marketing and sales, such as related to behavior modification relating to addictive or compulsive behavior such as compulsive gambling or compulsive shopping, and otherwise.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

FIG. 1 shows a conceptual drawing of an example system including streamlining input of information.

FIG. 2A shows a conceptual drawing of an example user interface, and related elements.

FIG. 2B shows a conceptual drawing of a method of using an example user interface.

### DETAILED DESCRIPTION

### Example System Elements

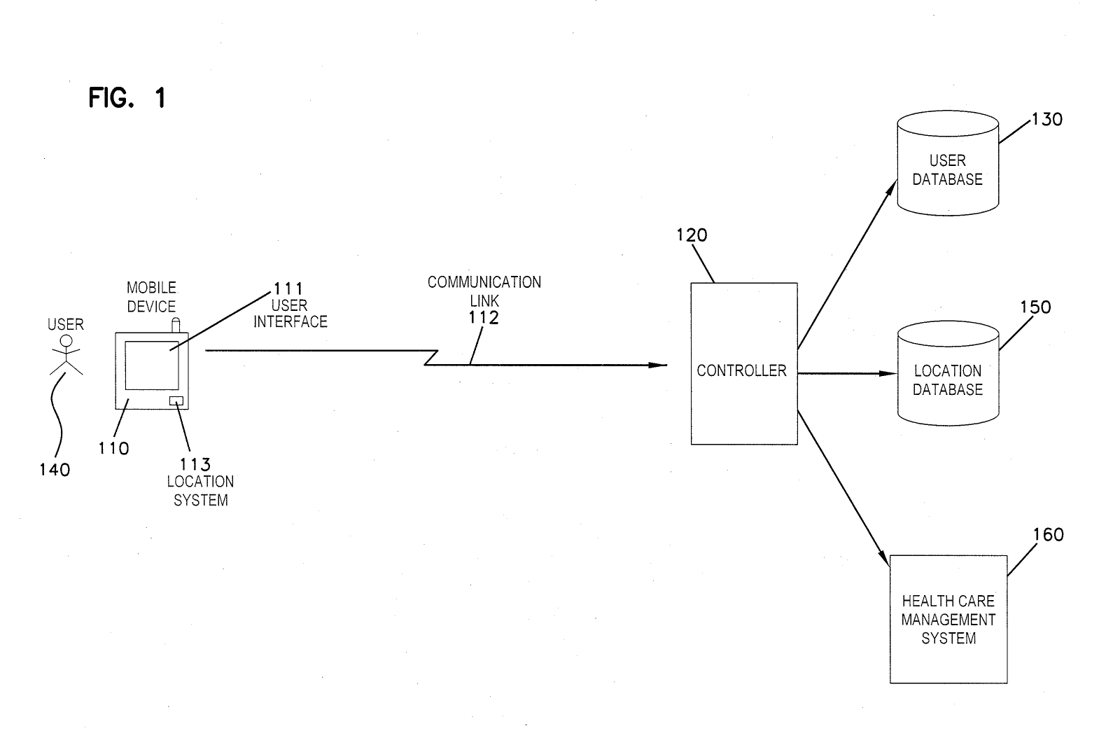

FIG. 1 shows a conceptual drawing of an example system including streamlining input of information.

An example streamlining system includes a mobile device 110, a controller 120, and a user database 130, interacts with a user 140, who is not part of the system, and has access to a location database 150, which is optionally part of the system, and optionally interacts with a healthcare management system 160.

Elements of the system are described herein with respect to one or more possible embodiments, and are not intended to be limiting in any way. In the context of the invention, there is the particular requirement for any such limitations as described with respect to any elements of the system. For example, individual elements of the system 100 could be replaced with substitutes which perform similar functions. Moreover, as described herein, many individual elements of the system are optional, and are not required for operation.

Although one or more elements of the system are described herein as being executed as if on a single computing device, in the context of the invention, there is no particular requirement for any such limitation. For example, the one or more computing devices can include a cluster of devices, not necessarily all similar, on which the element's functions are performed, such as a cloud computing execution platform or cluster computing platform. Also, while this application generally describes one or more elements of the system as distinct, in the context of the invention, there is no particular requirement for any such limitation. For example, the one or more elements of the system could include common elements, or could even be substantially the same devices, such as one or more such devices performing the functions of distinct elements as separate processes or threads. For example, a smartphone or similar mobile device can perform the functions for one or more elements of the system, including the controller and databases, as described herein or similarly.

Mobile Device.

In one embodiment, the mobile device no is disposed for being carried by the user 140, and can include a smart phone or similar mobile device. More generally, the mobile device no includes a user interface 111, a communication link 112 with the controller 120, and a location system 113.

In one embodiment, the user interface 111 can include an audiovisual display and a set of input elements. For a first example, the mobile device no can include a smart phone with a touch screen, in which the touch screen concurrently presents both an audiovisual display (using the screen and optionally, one or more speakers) and a set of input elements (using touch capabilities of the screen and optionally, one or more microphones which can receive voice input). For a second example, the mobile device no can include an SMS or MMS interface capable of communicating messages between the user interface 111 and the controller 120. In alternative embodiments, the user interface 111 can include another type of user presentation element, such as a motion-sensitive input element and a haptic output element, such as a smartphone set to a “vibrate” mode. In such alternative embodiments, there is no particular requirement for a smartphone, touchpad, or system-controlled audiovisual display.

In one embodiment, the communication link 112 can include any method by which the mobile device no can exchange information with the controller 120, or with other devices coupled to the controller 120. For example, when the mobile device no can includes a smart phone, the wireless communication link can include a wireless communication link, such as a cellular data system link, a cellular telephone link, an internet communication link, or otherwise.

In one embodiment, the location system 113 can include a position identification system, such as a global positioning system (GPS) device, or a device for another type of positioning system. For example, when the mobile device no includes a smart phone or similar device, the position identification system can include a GPS device or can include a positioning system making use of a cellular phone system to identify a location of the mobile device 110.

In alternative embodiments, the location system 113 can include a virtual location identification system, such as a bar code, magnetic stripe reader, near field communicator, QR code, smart card, or other device, by which the mobile device no can recognize a virtual location. A “virtual location” generally refers to any identifiable representation of a location, such as (A) a mobile establishment, such as a food truck or ice cream truck, (B) a group of establishments which have established a standard set of menu items, such as a franchise like McDonald's™ for food or Curves™ for exercise. For example, a roving sales troupe of Girl Scouts™ could carry with them a readable QR code that the mobile device no can read whenever the user buys cookies. Similarly, a restaurant could maintain a readable bar code on its menu that the mobile device no can read whenever the user dines there.

The mobile device no can include anything capable of interacting with the user 140, such as by presenting content to the user 140, and by receiving responses from the user 140. For example, the mobile device 110 could include a desktop or laptop computer with a monitor, keyboard and pointing device; a netbook, tablet or touchpad computer with a monitor and touchscreen; a smartphone, mobile phone or media presentation device such as an iPhone™ or iPad™, or other devices.

In one embodiment, the mobile device 110 includes a processor and memory or storage, the latter including instructions which the processor is capable of executing or interpreting, the instructions directing a processor to perform operations as described herein. For example, the mobile device no includes instructions for operating the communication link 112 and communicating with the controller 120 as described herein, and for presenting the user interface 111 to the user 140 as described herein.

For example, the mobile device 110 can send location information the controller 120, can obtain (from the controller 120, or optionally, the location database 150) information regarding enterprises in response to that location information, can obtain (from the controller 120, or optionally, the location database 150) information regarding activities in response to that location information, can (using the user interface 111) present activity choices to the user 140 in response to that information regarding enterprises and that information regarding activities.

For example, the mobile device 110 can (using the user interface 111) receive actual activity choices from the user 140, and can send information with respect to those actual activity choices to the controller 120 in response thereto.

Controller.

In one embodiment, the controller 120 includes a computing device capable of receiving information from the mobile device 110, exchanging information with the user database 130, exchanging information with the location database 150, and exchanging information with the healthcare management system 160. In one embodiment, the controller 120 includes a processor and memory or storage, the latter including instructions which the processor is capable of executing or interpreting, the instructions directing a processor to per form operations as described herein.

For example, the controller 120 can receive location information from the mobile device 110, can obtain (from the location database 150) information regarding enterprises in response to that location information, can obtain (from the location database 150) information regarding activities in response to that location information, and can send information to the mobile device 110 for presentation to the user 140.

For example, the controller 120 can receive (from the user database 130) preference information with respect to the user 140, can determine one or more activity choices having relatively high probability for the user 140, and can send preference information to the mobile device 110 for presentation to the user 140.

For example, the controller 120 can receive (from the mobile device 110) actual activity choices with respect to the user 140, can maintain information in the user database 130 with respect to those actual activity choices, and can exchange information with the healthcare management system 160 with respect to those activity choices. Moreover, the controller 120 can update its assessment of probability for one or more activity choices with respect to the user 140 in response to those actual activity choices.

User Database.

In one embodiment, the user database 130 includes information regarding the user 140, and optionally includes information regarding one or more other users, such as in a population similarly situated to the user 140, or otherwise having a relationship with the healthcare management system 160.

In one embodiment, the user database 130 can include information with respect to those locations, enterprises, and activities with which the user 140 has been engaged. In particular, the user database 130 can identify those activities the user 140 has previously selected with respect to those enterprises. For example, as described above, where the enterprise includes a restaurant, the user database 130 can include a set of recent items which the user 140 has ordered from the menu. This has the effect that the controller 120 can determine which items the user 140 is most likely to next order from the menu at the same establishment.

In alternative embodiments, the user database 130 can include information with respect to a history of behavior of the user 140, a set of probabilities with respect to each menu item with respect to the user 140, or other information indicative of what action the user 140 is likely to take at each establishment.

In addition, the user database 130 can include information with respect to the user 140 and actions likely to be taken by similarly situated users, such as information with respect to the user's specific attributes, including without limitation one or more of: age, gender, health history, and socioeconomic status. For example, the user database 130 might include statistical information collected by interaction with other users with similar attributes (one or more such attributes, in which the actual attributes are similar, or some combination in response to one or more such attributes, in which the combination is similar).

Location Database.

In one embodiment, the location database 150 includes information relating physical locations (and virtual locations) to enterprises, relating enterprises to activities, or optionally, directly relating physical locations to activities. For a first example, the location database 150 can relate a particular physical location to a known eating establishment, such as a fast food restaurant or to a another type of restaurant, to a known exercise location, such as a gymnasium, recreational park, or swimming pool, or to another type of location. For a second example, the location database 150 can relate a particular physical location to one or more known activities that might be conducted there, such as walking, sitting, running, jogging, swimming, or boating. In some embodiments, the location database 150 could include information relating the physical location or virtual location of the enterprise to differing menus that relate to different times, such as times of day, days of the week, or seasons of the year.

In each such case, the location database 150 can relate the identified enterprise to one or more activities. For example, where the location database 150 relates the particular location to a restaurant (or equivalent), the location database 150 can also identify one or more activities for that restaurant, with the effect of identifying the particular location with a menu of possible eating activities. Similarly, where the location database 150 relates the particular location to a fitness center (or equivalent) where exercise is possible, the location database 150 can also identify one or more activities, with the effect of identifying the particular location with a menu of possible exercises.

In the context of the invention, there is no particular requirement that a menu for an enterprise 211 (as described below) includes food activities. For example, an enterprise 211 menus can include exercise activities, or can include calorie neutral activities (such as might be found at an enterprise such as a library), or more than one thereof, such as an enterprise 211 which combines more than one of the types of activities noted herein.

Healthcare Management System.

In one embodiment, the healthcare management system 160 includes a computing device capable of receiving and maintaining healthcare information about the user 140, exchanging information with the controller 120 and with the user database 130, and identifying best healthcare practices for the user 140. For example, the healthcare management system 160 can identify one or more nutrition or exercise regimens for the user 140 which are relatively superior, such as might be improvements over a historic nutrition regimens actually practiced by the user 140.

For example, if the healthcare management system 160 determines that the user 140 is practicing a nutrition regimen which involves intake of excessive calories (with insufficient activity to balance that intake), the healthcare management system 160 can recommend a relatively superior nutrition and exercise regiment in which the user 140 takes in fewer, or expends more, calories, such as by maintaining less eating or by maintaining greater activity. The healthcare management system 160 can send information to the controller 120, which can, as described below, send that information to the mobile device 110, which can present that information (using the user interface 111) to the user 140.

### Example User Interface

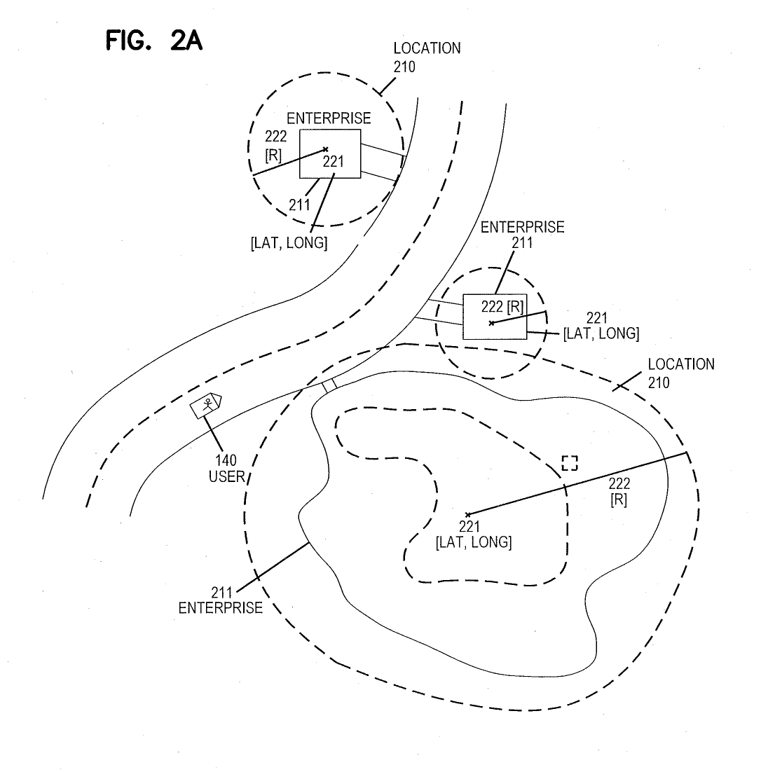

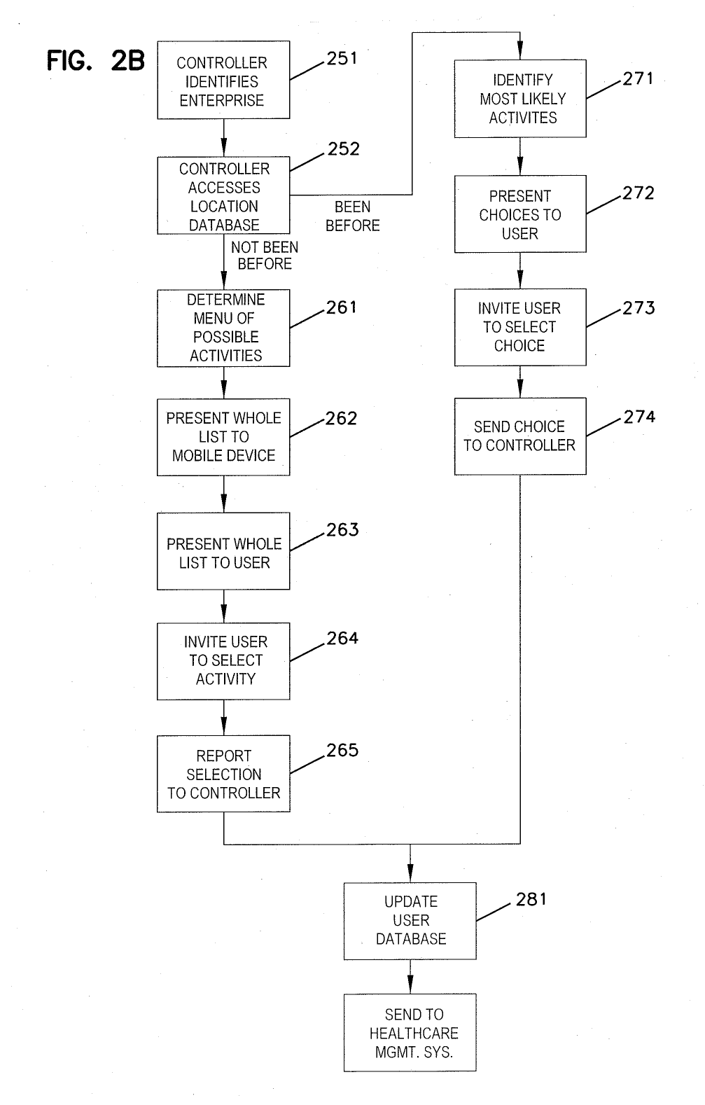

FIG. 2A shows a conceptual drawing of an example user interface, and related elements.

FIG. 2B shows a conceptual drawing of a method of using example user interface.

Location Identification.

In an example system including streamlining input of information, the location database 150 can include, as described above, information associating one or more locations 210 with enterprises 211, and information associating one or more enterprises 211 with activities 212 that might be performed at those locations 210 or at those enterprises 211.

For example, in one embodiment, the location database 150 can include information identifying a region 220 for an identified enterprise 211, such as a set of coordinates 221 [lat, long] defining a latitude and longitude for that region 220, and a radius [R] defining a range 222 from those coordinates 221 in that region 220. The mobile device 110, from time to time, such as periodically (or alternatively, aperiodically, such as randomly or pseudorandomly), sends its own physical location 230 (using the location system 113) to the controller 120, which matches that location 230 against the location database 150.

An example set of locations can include a first enterprise, such as a “fast food” business establishment, a second enterprise, such as a “healthy food” business establishment, and a third enterprise, such as an exercise business establishment. The first enterprise, second enterprise, and third enterprise are shown coupled to one or more roads, upon which the user 140 might travel, such as in a motor vehicle.

In one embodiment, each enterprise is so-called as a convenience. In the context of the invention, there is no particular requirement that any enterprises in actual business, or is for-profit, or is even considered a well-defined area in everyday life. For example and enterprise can include a beach, a park, or a recreational area.

As described herein, in the context of the invention, there is no particular requirement that an “enterprise” is a business, or for profit, or even a well-defined area. For example, an “enterprise” could be a hiking trail, a recreational park, a scenic location, or otherwise.

In one embodiment, at a step 251 (shown in the FIG. 2B) when the mobile device 110 enters the region 220 (such as, within the radius [R] from the coordinates 221 [lat, long] associated with a particular enterprise 211), and the controller 120 receives the physical location 230 of the mobile device 110, the controller 120 identifies whether the mobile device 110 is located within the region 220 associated with that enterprise 211, and the controller 120 sends a message to the mobile device 110 to inform the mobile device 110 that it has entered the region 220 associated with that particular enterprise 211.

If there is more than one enterprise 211 associated with a particular region 220, the controller 120 can attempt to determine which of the more than one such enterprise 211.

For a first example, the controller's choice of particular enterprise 211 could be in response to rules, such as (A) in response to which enterprises 211 the user 140 is most likely to frequent, (B) in response to where the user 140 is typically found at particular times of day, (C) in response to the most recent enterprise 211 at which the user 140 was found, (D) in response to on what road the user was most recently traveling.

For a second example, the controller's choice of particular enterprise 211 could be in response to an input from the user 140, such as (A) in response to a keyword or tag associated with one such enterprise 211 associated with the particular region 220, (B) in response to a hierarchical menu of enterprises 211 the user 140 might frequent and that are associated with the particular region 220, (C) a combination or conjunction of keywords or tags, and a hierarchical menu, selectable by the user 140.

As described above, in addition to or instead of a physical location, a virtual location can define an enterprise 211. For example, in addition to or instead of coordinates [lat, long] and a radius [R], a known code can define an enterprise 211. As described above, a bar code, magnetic stripe reader, near field communicator, QR code, smart card, or other device, can identify the known code to the mobile device 110 when the user 140 approaches the virtual location.

As also described above, in addition to or instead of a location, a time or set of times can define an enterprise 211. For example, a physical (or virtual) location from 6:00 a.m. to noon can define a first enterprise 211, while the same physical (or virtual) location from noon to 11:00 p.m. can define a first enterprise 211. This could be convenient or effective for enterprises 211 that change their menu between breakfast and lunch, or between lunch and dinner.

User Interface.

In one embodiment, at a step 252, the controller 120 accesses the user database 130 to determine if the user 140 has frequented that particular enterprise 211 before. If not, the method proceeds with a step 261, in which the controller 120 accesses the location database 150 to determine the menu of possible activities associated with that particular enterprise 211. As described above, the location database 150 can identify a menu including one or more eating activities, one or more exercise activities, or both.

For example, in a step 262, the controller 120 can send a message to the mobile device 110 identifying the one or more activities available at that enterprise 211, and can present a list of those activities to the mobile device 110. In a step 263, the mobile device 110 can present a list 231 of those one or more activities to the user 140, possibly with scroll affordances 232 to allow the user 140 to select from that list 231 when the list 231 is more lengthy than can easily be presented in one screen. In a step 264, the mobile device no can invite the user 140 to select one or more of those activities as having been conducted.

For example, as described above, if the enterprise 211 includes a restaurant, and the menu includes “a cheeseburger”, the user 140 can identify to the mobile device 110 that a cheeseburger was ordered and consumed. Where there is more than one similar activity, the step 263 can include substeps in which (A) the mobile device 110 can present those similar activities in a group, (B) the mobile device 110 allows the user 140 to select the group, (C) the mobile device 110 presents the individual activities within the group, and (D) the mobile device 110 allows the user 140 to select one of those individual activities.

In one embodiment, the mobile device no can alert the user 140, such as by beeping or otherwise emitting an audiovisual marker, associated with presenting one or more choices to the user 140. Similarly, the mobile device 110 can provide the user 140 with a predetermined amount of time in which to make a choice, after which the mobile device 110 can either (A) determine that the user 140 has chosen none of the presented possible activities, in which case the mobile device 110 can indicate to the controller 120 that no activity was performed, (B) determine that the user 140 has not made a choice, in which case the mobile device 110 can indicate to the controller 120 that no activity was performed, or that a default activity was performed, (C) determine that the user 140 is still thinking about their choice, in which case the mobile device no can offer the user 140 more time to make a choice, offer the user 140 other possible choices, or otherwise, (D) determine that the user 140 is not responsive to the mobile device no, in which case the mobile device 110 can indicate to the controller 120 that the user 140 is unreliable about choosing activities, or otherwise.

Once the user 140 has selected one or more such activities, in a step 265, the mobile device no sends a message to the controller 120 identifying the one or more activities selected by the user 140. In a step 266, the controller 120 receives the message, updates the user database 130 with the one or more activities selected by the user 140, and notes, where applicable, that the user 140 has now frequented that particular enterprise 211.

If it occurs that the controller 120 determines that the user 140 has in fact already frequented that particular enterprise 211, in a step 271, the controller 120 sends a message to the mobile device 110 identifying the one or more activities most likely to be selected by the user 140. In one embodiment, these will include only a relatively few choices of possible activities, such as possibly three to five possible most-likely activities (with the actual number being selectable depending upon a particular embodiment), and optionally with an additional choice for “other”, in the event the user 140 wishes to identify an activity other than one or more of those relatively few choices.

In a step 272, the mobile device no presents those relatively few choices of possible activities to the user 140. In a step 273, the mobile device 110 allows the user 140 to select one or more of those relatively few choices. If the user 140 selects one or more of those relatively few choices, in a step 274, the mobile device no enters those one or more of those relatively few choices, sends a message to the controller 120 indicating which one or more the user 140 chose, and continues with the next step.

In a step 274, if the user 140 chose “other”, the mobile device 110 sends a message to the controller 120 to that effect, and the controller 120 continues with the step 262, at which the controller 120 sends a message to the mobile device 110 identifying the one or more other activities available at that enterprise 211.

Whether the user 140 (A) selects one or more of the relatively few choices at the step 273, or (B) selects one or more of the possible activities at the step 264, the method continues with the step 281, at which the controller 120 receives the user's choice and updates the user database 130. At a step 282, the controller 120 optionally sends a message to the healthcare management system 160, indicating the user's choice, and prompting the healthcare management system 160 to update its information about the user 140.

Generality of User Interface.

In the context of the invention, the controller 120 can maintain a list of more than just a relatively few most likely activities for each such enterprise 211. For example, the controller 120 can maintain a set of relative probabilities or other weightings associated with each activity associated with an enterprise 211 (for each such user 140), and can select the relatively few activities with the most likely probabilities or the best weightings for presentation to the user 140, in response to the user 140 approaching or entering the enterprise 211.

As described above, the controller 120 can adjust the probabilities or weightings in response to choices made by the user 140, in response to choices declined by the user 140, or in response to choices or made or declined by other users 140 who are similarly situated For a first set of examples, users 140 who are similarly situated can include users 140 who (A) are in similar demographic groups, who (B) have made or declined similar choices in the recent past, who (C) are similarly located as the user 140, such as being in the same location or the same enterprise 211 as the user 140, especially when those other users have approached or entered the enterprise 211 at the same time as the user 140.

The controller 120 can also adjust an initial set of probabilities or weightings, with the effect that the controller 120 can present a relatively smaller number of choices to the user 140, even if the user 140 has not frequented that enterprise 211 before. For example, if the controller 120 is aware that a particular enterprise's most popular activity is to order a cheeseburger, the controller 120 can so inform the mobile device 110 and present that choice to the user 140 as one of a relatively smaller number of choices even when the user 140 has not frequented that enterprise 211 before.

The controller 120 can also adjust the set of probabilities or weightings at a first enterprise 211, in response to changes in the user's choices at a second enterprise 211. For example, if the user 140 declines to order a cheeseburger at a first enterprise 211, the controller 120 can reduce the probability or weighting associated with the user 140 ordering a cheeseburger at a second enterprise 211 as well. Similarly, the controller 120 can adjust the set of probabilities or weightings at an enterprise 211 in response to changes in the menu available at that enterprise 211. For example, if the enterprise 211 adds a menu item which is favored by the user 140 at a first enterprise 211, the controller 120 can adjust the set of probabilities or weightings at a second enterprise 211 to add a relatively high probability or relatively significant weighting, in response to that menu item having been added at the second enterprise 211.

Similarly, the controller 120 can adjust the set of probabilities or weightings in response to other factors, including without limitation (A) time of the day, or day of the week, (B) recent user activity, such as whether the user 140 has recently eaten or recently exercised, or whether the user 140 has recently been to a medical visit, (C) activity external to the user 140, such as whether the health management system 160 has recommended an activity, or recommended against an activity, for the user, and otherwise. For example, the controller 120 can adjust the set of probabilities or weightings in response to up to date data which is collected about the user 140.

Extensions of User Interface.

In alternative embodiments, the controller 120 can send one or more messages to the mobile device 110, including recommendations for activities to the user 140. For example, if the if the user 140 regularly orders a cheeseburger at a particular enterprise 211, the controller 120 can send a message to the mobile device 110, when the user 140 approaches or enters that particular enterprise 211, to suggest an alternative selected activity. The controller 120 can interface with the health management system 160 to identify a relatively superior suggestion to make and present to the user 140, such as (A) to order a hamburger, that is, a cheeseburger without the cheese, (B) to order a chicken sandwich, that is, a food item with fewer calories, less fat, or other nutritional advantages over a cheeseburger, (C) to order a salad, that is, a food item with much greater nutritional advantages over a cheeseburger, (D) to conduct an exercise activity, such as a 30-minute walk, along with the cheeseburger, or otherwise.

In alternative embodiments, the controller 120 can send one or more messages to the mobile device 110, describing the nature of the establishment 211, or its menu, with respect to one or more keywords, with respect to a hierarchical set of menu items, or with respect to a taxonomy of menu items.

For a first example, the mobile device no can present the menu to the user 140 in sections, such as “beverages”, “salads”, “sandwiches”, and otherwise. In such examples, when the user 140 selects one or more sections, the mobile device no can present menu items with respect to that section. This has the effect that if the user 140 selects “beverages”, the mobile device no could present the user's most commonly chosen beverages, optionally with suggested beverages, and other beverages.

For a second example, the mobile device no can present the menu to the user 140 with respect to keywords or tags, such as “low calorie”, “sandwiches”, “vegetarian”, and otherwise. In such examples, when the user 140 selects one or more keywords or tags, the mobile device no can present menu items with respect to those keywords or tags. This has the effect that if the user 140 selects “sandwiches” and “vegetarian”, the mobile device no could present the user's most commonly chosen items that meet those keywords (either conjunctively or disjunctively, such as at the user's direction), optionally with suggested items meeting those keywords, and other items meeting those keywords.

### Alternative Embodiments

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

Certain aspects of the embodiments described in the present disclosure may be provided as a computer program product, or software, that may include, for example, a computer-readable storage medium or a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

1. A method, including steps of
receiving location information associated with a user;
determining one or more activities associated with said location information;
identifying a subset of said activities, said subset considered more likely with respect to said user;
requesting said user to select one or more of said activities from said subset, said steps of requesting preferring activities from said subset over activities not from said subset.

2. A method as in claim 1, including steps of
associating medical information with at least one of said activities, said medical information including information relating to one or more of:
alcohol use, tobacco use, sleep, stress and resiliency, back strain, back pain, diabetes, pre-diabetic conditions, weight loss, nutrition, exercise.

3. A method as in claim 1, including steps of
updating said subset in response to a change in said activities associated with said location information.

4. A method as in claim 1, including steps of
updating a database of user activities in response to an answer to said request.

5. A method as in claim 4, wherein
said steps of updating a database include steps of updating said subset.

6. A method as in claim 1, wherein
said steps of receiving location information include steps of
associating a mobile device with said user;
receiving said location information from said mobile device.

7. A method as in claim 1, wherein
said steps of determining one or more activities include steps of
determining enterprise information associated with said location information;
determining said activities in response to said enterprise information.

8. A method as in claim 7, including steps of
updating said subset in response to said enterprise information.

9. A method as in claim 7, including steps of
determining if said user has already visited at least one of said enterprises associated with said location information;
when said user has not already visited at least one of said enterprises, requesting said user to identify a preferred one or more of said activities associated with said location information.

10. A method as in claim 9, wherein
said steps of identifying a subset of said activities include steps of
identifying a first set of characteristics, said first set of characteristics relating to said user;
identifying a second set of characteristics, said second set of characteristics being similar to said first set of characteristics;
including in said subset activities from a construct relating to said second set of characteristics.

11. A method as in claim 9, wherein
said steps of identifying a subset of said activities include steps of
identifying a set of characteristics for said user;
including in said subset activities relating to said set of characteristics.

12. A method as in claim 9, wherein
said steps of identifying a subset of said activities include one or more of:
including in said subset one or more events most likely to occur at that enterprise or location;
including in said subset one or more events recently occurring at that enterprise or location;
including in said subset said preferred one or more of said activities.

13. A method as in claim 9, wherein
said steps of identifying a subset of said activities include steps of
identifying a set of characteristics for said user;
including in said subset activities from a second user having a similar set of characteristics.

14. A method as in claim 13, wherein
said characteristics include one or more of: demographic information, medical information.

15. A method as in claim 13, wherein
said second user includes a statistical construct of characteristics.

16. A method as in claim 7, wherein
said steps of determining enterprise information are responsive to a database of known enterprises, said database including one or more of: locations; hours of operation; and
said steps of determining enterprise information are responsive to one or more of: a time of day, a day of the week, one or more recent activities by said user.

17. A method as in claim 16, wherein
said input values from said user include one or more of: keywords, tags, selections in a hierarchy of possible enterprises.

18. A method as in claim 16, wherein
said locations include one or more virtual locations, said virtual locations being associated with one or more known codes; and
said steps of determining enterprise information are responsive to reading said one or more known codes.

19. A method as in claim 16, wherein
said steps of determining are responsive to one or more input values from said user.

20. A method as in claim 1, wherein
said steps of requesting include a timeout duration.

21. A method as in claim 20, including, in response to said timeout duration, one or more of:
steps of aborting said steps of requesting;
steps of selecting one or more of said activities on behalf of said user;
steps of updating a reliability associated with said user.
